(19) United States
(12) Patent Application Publication
(10) Pub. No.: US 2019/0079298 A1
(43) Pub. Date: Mar. 14, 2019

(54) METHOD EXECUTED ON COMPUTER FOR PROVIDING CONTENTS IN TRANSPORTATION MEANS, PROGRAM FOR EXECUTING THE METHOD ON COMPUTER, CONTENTS PROVIDING APPARATUS, AND CONTENTS PROVIDING SYSTEM

(71) Applicant: COLOPL, Inc., Tokyo (JP)

(72) Inventors: Yudai SHOJI, Tokyo (JP); Seiji SATAKE, Tokyo (JP)

(21) Appl. No.: 16/128,519

(22) Filed: Sep. 12, 2018

(30) Foreign Application Priority Data
Sep. 13, 2017 (JP) 2017-175822

(51) Int. Cl. G02B 27/01; H04N 21/258; H04N 21/414

(52) U.S. Cl. CPC G02B 27/0172; H04N 21/25891; H04N 21/41422; G02B 2027/014; G02B 2027/0123; G02B 2027/0138; G02B 2027/0187

(57) ABSTRACT

[Problem to be Solved] To provide content suitable for a user wearing an HMD in means of transportation.

[Solution to Problem] According to at least one embodiment of this disclosure, a method includes: by using a computer associated with means of transportation for moving a user to a goal, specifying an attribute of the user and the destination; determining first content from among a plurality of content candidates based on the specified attribute and the specified goal; defining a virtual space; playing the content in the virtual space; detecting a motion of a head-mounted device (HMD) associated with the computer; specifying a field of view (FOV) in the virtual space in accordance with the detected motion; and displaying an image corresponding to the FOV on the HMD.

### TECHNICAL FIELD

The present disclosure relates to provision of content in means of transportation, and more specifically to a technique for providing content via a virtual space.

### BACKGROUND

With the widespread availability of what are called low-cost carriers (LCCs), an increasing number of travelers come from or go abroad. Typical LCCs do not provide in-flight entertainment to achieve lower cost. Regarding in-flight entertainment, for example, JP 2016-213824 A (Patent Document 1) discloses “a system and method that enable passengers in an aircraft to receive service having desired quality with respect to in-flight entertainment (IFE) content distribution” (see Abstract).

### CITATION LIST

### Patent Document

[Patent Document 1] JP 2016-213824 A

### SUMMARY

### Solution to Problem

According to at least one embodiment of this disclosure, there is provided a method. The method includes: by using a computer associated with means of transportation for moving a user to a goal, specifying an attribute of the user and the destination; determining first content from among a plurality of content candidates based on the specified attribute and the specified goal; defining a virtual space; playing the content in the virtual space; detecting a motion of a head-mounted device (HMD) associated with the computer; specifying a field of view (FOV) in the virtual space in accordance with the detected motion; and displaying an image corresponding to the FOV on the HMD.

The above-mentioned and other objects, features, aspects, and advantages of the disclosure may be made clear from the following detailed description of this disclosure, which is to be understood in association with the attached drawings.

### BRIEF DESCRIPTION OF DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a detailed configuration of modules in a computer according to at least one embodiment of this disclosure.

FIG. 15 A diagram of a mode in which a user is moving from a place of departure 1542 to a destination 1545 using means of transportation 1541.

FIG. 16 A diagram of details of user information 1433.

FIG. 17 A diagram of details of content data 1434.

FIG. 18 A diagram of details of history data 1435.

FIG. 19 A diagram of a configuration of a content management module 1427.

FIG. 20 A flowchart of processing to be executed by a computer 200 according to at least one embodiment of this disclosure.

FIG. 21 A diagram of a mode of providing content to a user going to Taiwan.

FIG. 22 A diagram of content provided in such a case in which a traveler who visited Osaka is going back home.

FIG. 23 A flowchart of processing to be executed by a processor 210 in the computer 200.

FIG. 24 A diagram of a display mode in a monitor 2499 provided to an aircraft.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

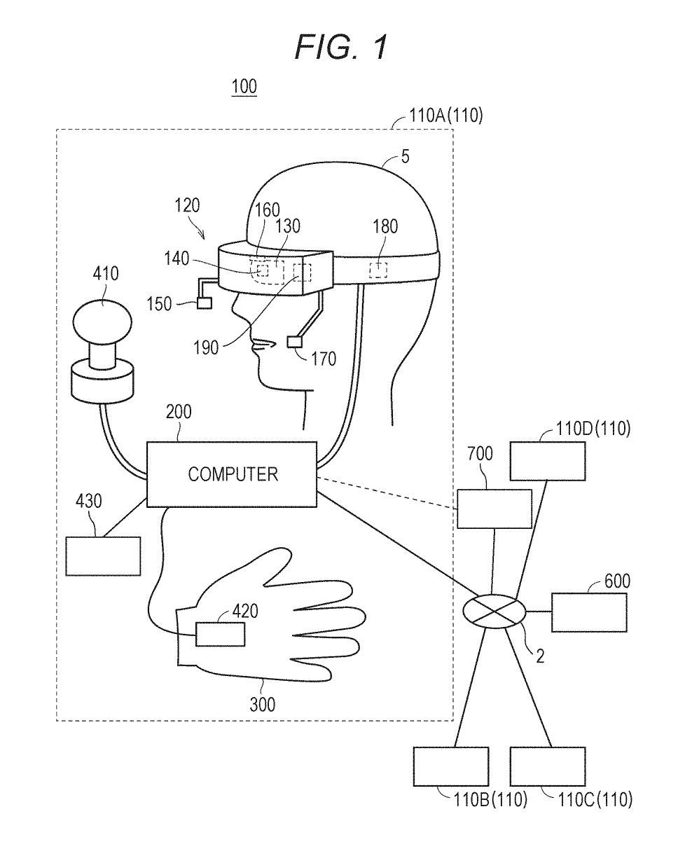

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

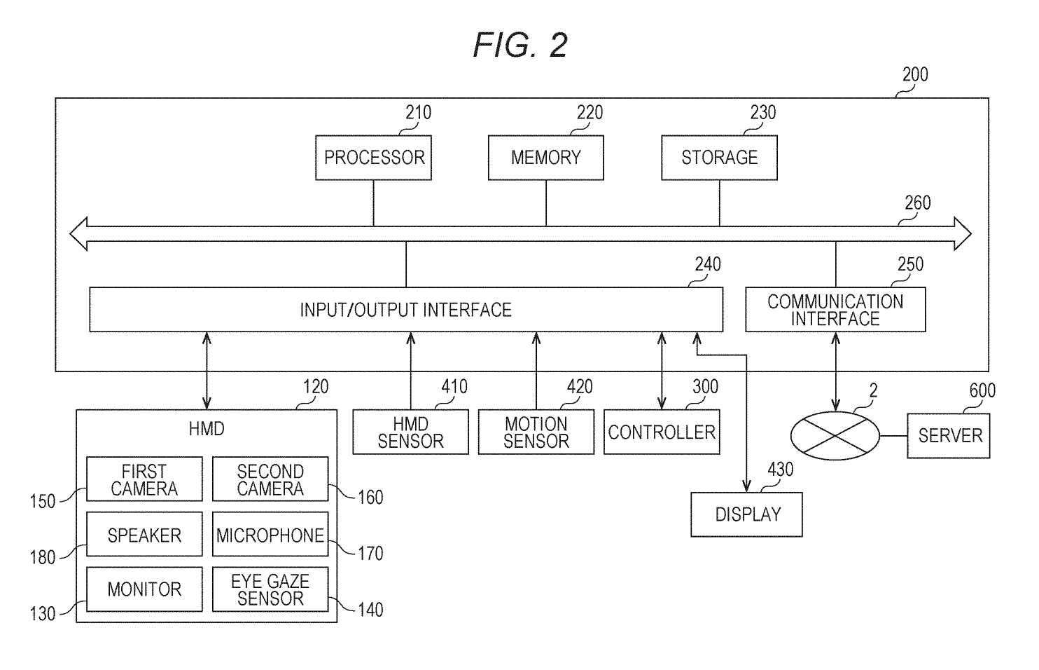

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

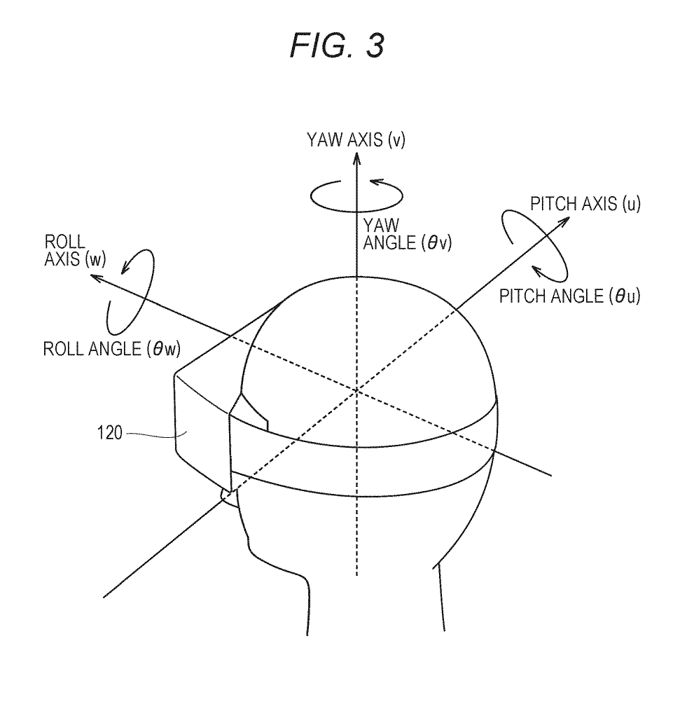

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

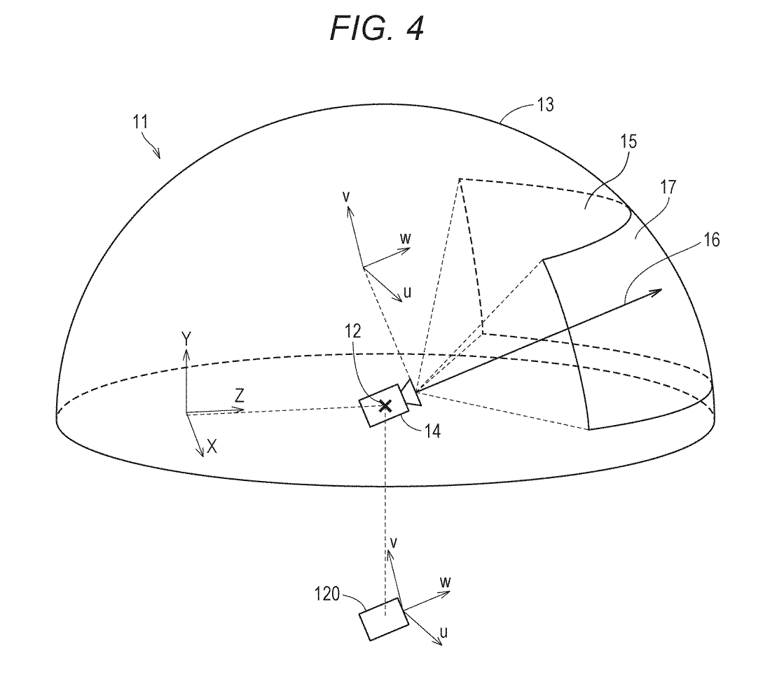

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

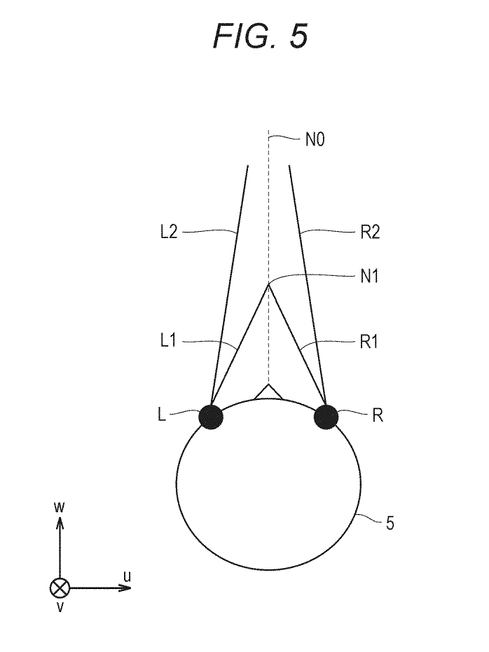

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight NO. The line of sight NO is a direction in which the user 5 actually directs his or her lines of sight with both eyes. The line of sight NO corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

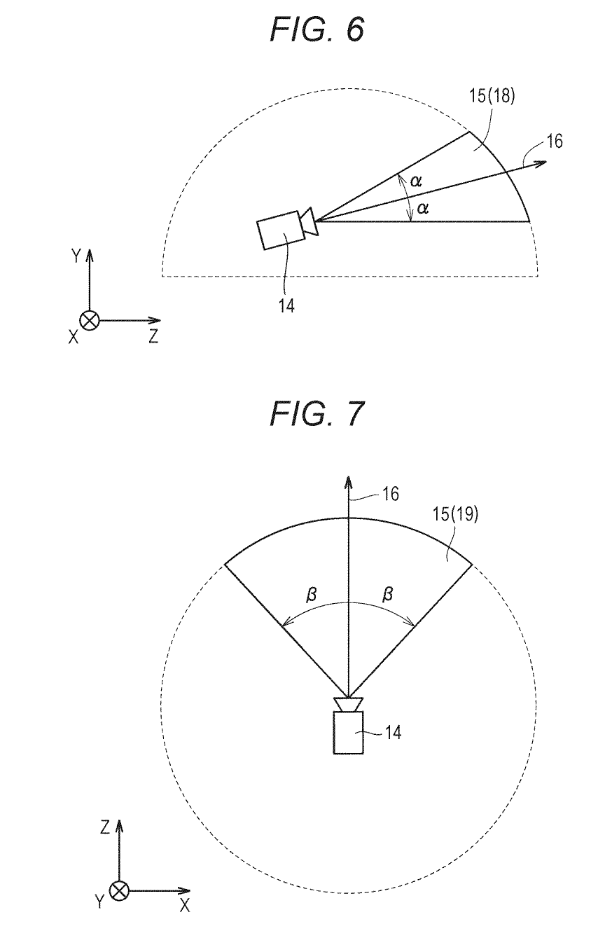

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

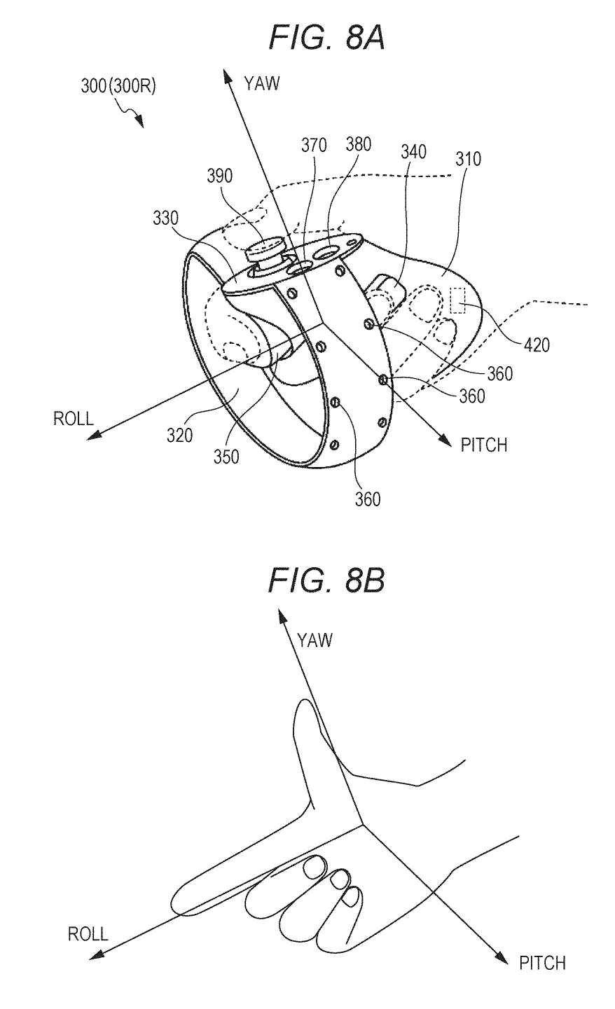

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

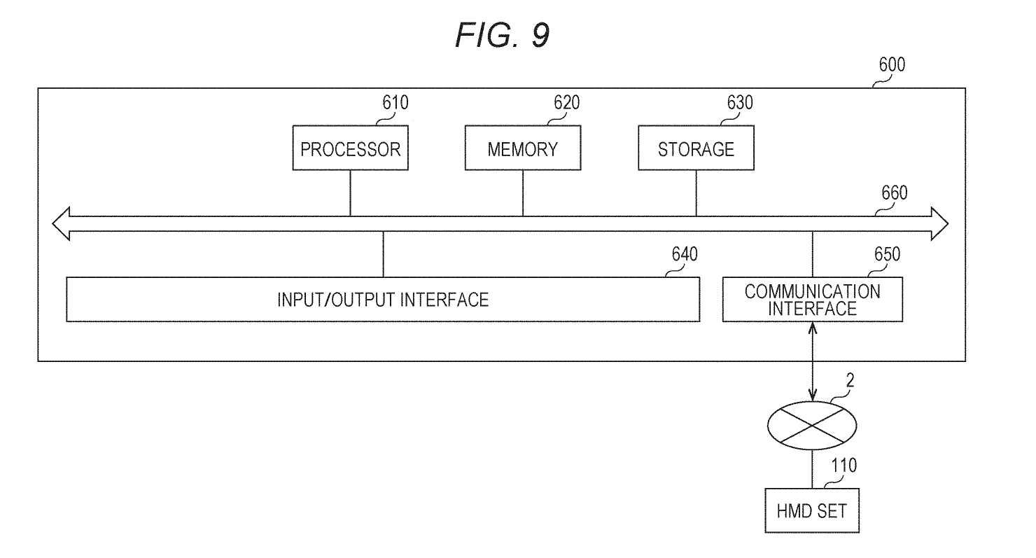

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

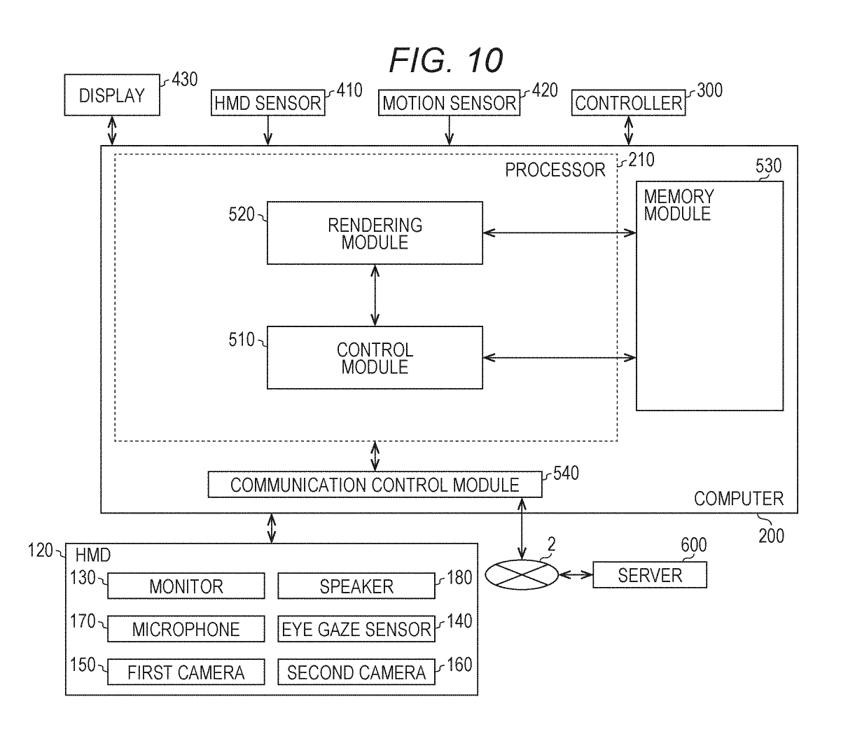

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may be provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

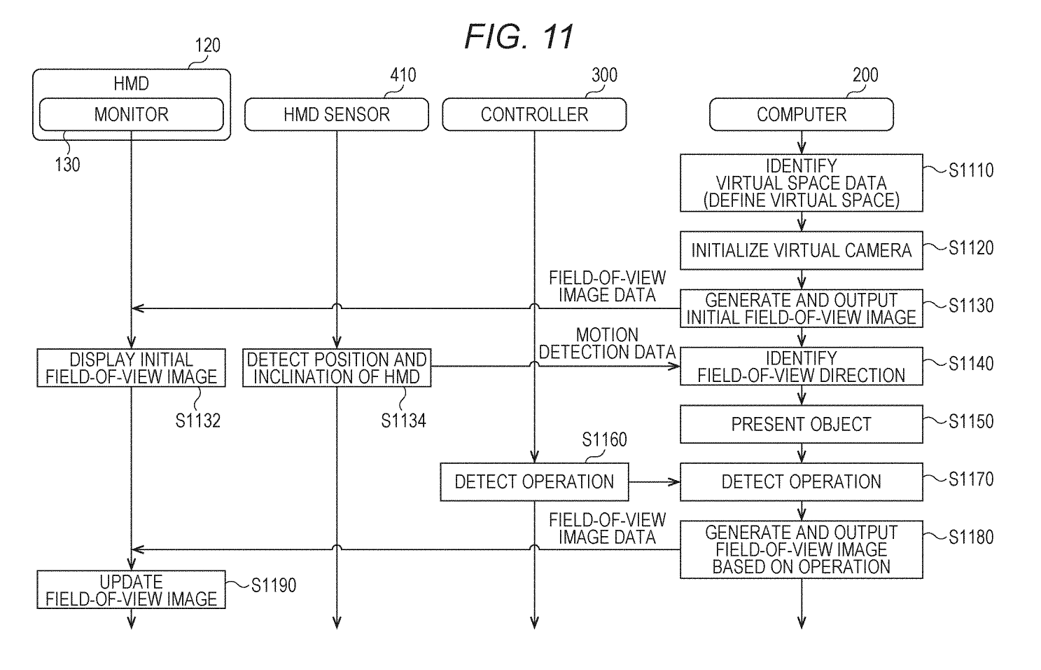

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

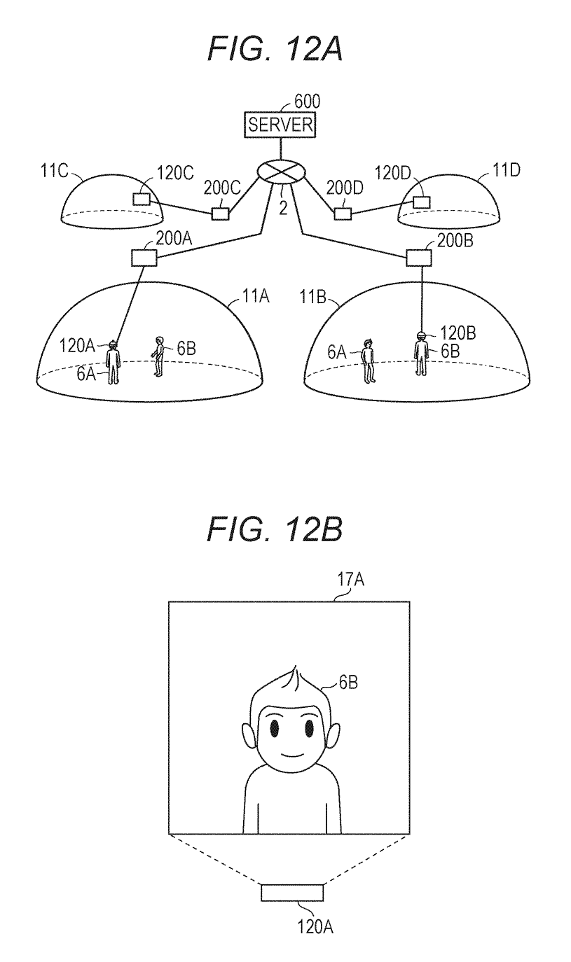

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

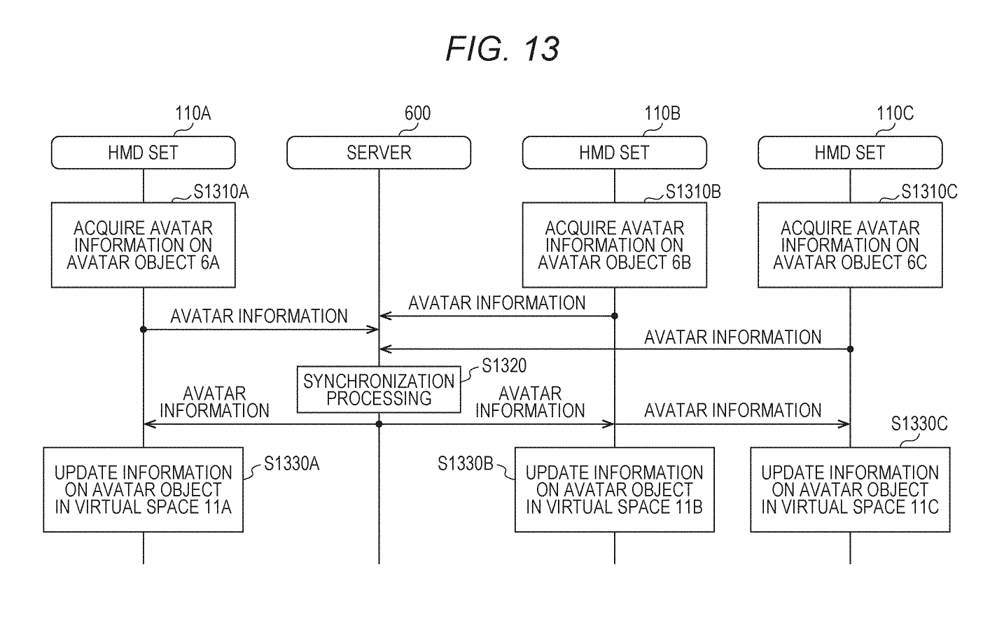

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

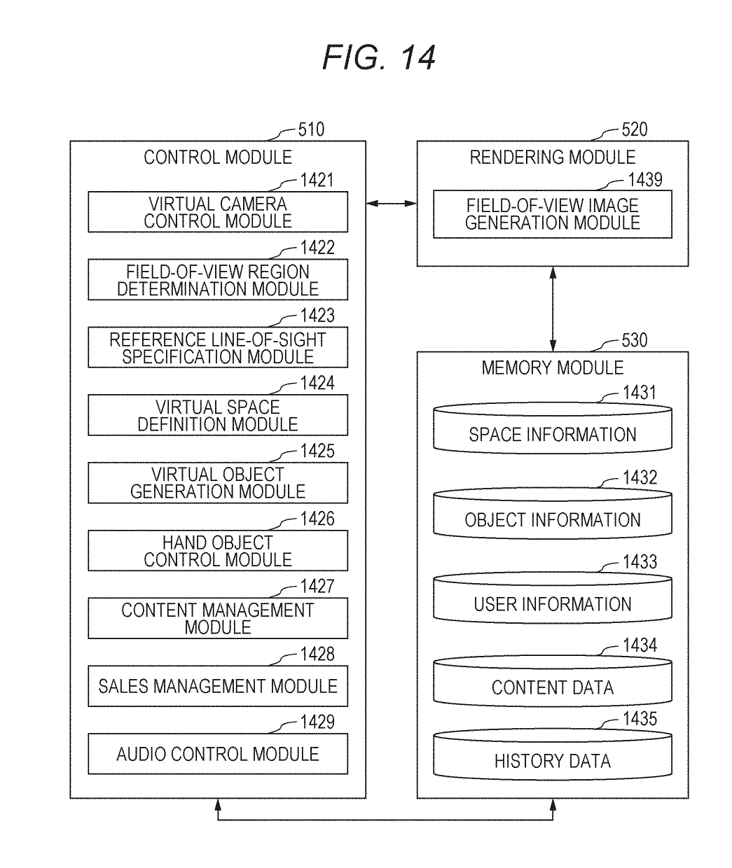

With reference to FIG. 14, a detailed configuration of modules in the computer 200 is described. FIG. 14 is a block diagram of a detailed configuration of modules in the computer 200 according to at least one embodiment of this disclosure.

In FIG. 14, the control module 510 includes a virtual camera control module 1421, a field-of-view region determination module 1422, a reference line-of-sight specification module 1423, a virtual space definition module 1424, a virtual object generation module 1425, a hand object control module 1426, a content management module 1427, a sales management module 1428, and an audio control module 1429. The rendering module 520 includes a field-of-view image generation module 1439. The memory module 530 stores space information 1431, object information 1432, user information 1433, content data 1434, and history data 1435.

In at least one aspect, the control module 510 controls image display of the HMD 120 on the monitor 130. The virtual camera control module 1421 arranges the virtual camera 14 in the virtual space 11, and controls the behavior and direction of the virtual camera 14, for example. The field-of-view region determination module 1422 defines the field-of-view region 15 in accordance with the direction of the head of the user 5 wearing the HMD 120. The field-of-view image generation module 1439 generates data of a field-of-view image (also referred to as field-of-view image data) to be displayed on the monitor 130 based on the determined field-of-view region 15. The field-of-view image generation module 1439 also generates field-of-view image data based on data received from the control module 510. The field-of-view image data generated by the field-of-view image generation module 1439 is output to the HMD 120 by the communication control module 540. The reference line-of-sight specification module 1423 specifies the line of sight of the user 5 based on the signal from the eye gaze sensor 140.

The control module 510 controls the virtual space 11 provided to the user 5. The virtual space definition module 1424 generates virtual space data representing the virtual space 11, to thereby define the virtual space 11 in the HMD system 100.

The virtual object generation module 1425 generates data of objects arranged in the virtual space 11. Examples of the objects may include other avatar objects, virtual panels, virtual letters, and virtual post boxes. The data generated by the virtual object generation module 1425 is output to the field-of-view image generation module 1439.

The hand object control module 1426 arranges a hand object in the virtual space 11. The hand object corresponds to the right hand or the left hand of the user 5 holding the controller 300, for example. In at least one aspect, the hand object control module 1426 generates data for arranging the hand object corresponding to the right hand or the left hand in the virtual space 11. The hand object control module 1426 generates data for moving the hand object in accordance with an operation on the controller 300 made by the user 5. The data generated by the hand object control module 1426 is output to the field-of-view image generation module 1439.

In at least one aspect, if the motion of a part of the body of the user 5 (e.g., the motion of the left hand, the right hand, the left leg, the right leg, or the head) is associated with the controller 300, the control module 510 generates data for arranging a partial object corresponding to this part of the body of the user 5 in the virtual space 11. The control module 510 generates data for moving the partial object in accordance with an operation on the controller 300 made by the user 5 using the part of his/her body. The data is output to the field-of-view image generation module 1439.

The audio control module 1429, which has detected an utterance of the user 5 using the microphone 170 from the HMD 120, specifies the computer 200 to which voice data corresponding to the utterance is to be transmitted. The voice data is transmitted to the computer 200 specified by the audio control module 1429. The audio control module 1429, which has received voice data from the computer 200 of another user via the network 2, outputs audio information (utterances) corresponding to the voice data from the speaker 180.

The space information 1431 stores one or more templates defined in order to provide the virtual space 11.

The object information 1432 stores content to be played in the virtual space 11 and information for arranging objects used in the content. Examples of the content may include games and content representing landscapes similar to the ones in the real world. Furthermore, the object information 1432 includes data for arranging a hand object corresponding to a hand of the user 5 operating the controller 300 in the virtual space 11, data for arranging avatar objects of users in the virtual space 11, and data for arranging virtual panels or other objects in the virtual space 11.

The user information 1433 stores programs for causing the computer 200 to function as the control device of the HMD system 100 and application programs using various types of content stored in the object information 1432, for example. The data and programs stored in the memory module 530 are input by the user 5 of the HMD 120. Alternatively, the processor 210 downloads the programs or data from a computer (e.g., the server 600) that is managed by a business operator providing the content, and stores the downloaded programs or data in the memory module 530.

The content data 1434 is data on the content that is available in means of transportation (e.g., aircrafts, trains, ships). Examples of the content data 1434 include videos for introducing tourist sites in or near the flight destination of the aircraft, videos for introducing products and services available there, and what is called in-flight entertainment including movies and dramas.

The history data 1435 includes content distribution and viewing histories. The distribution history includes the name of the user (passenger name) to which the content was distributed and the date and time at which the content was distributed. The viewing history may include, for each type of content, identification information of the user to which the content was distributed, his/her line-of-sight history, and variations in the posture of the corresponding HMD 120, for example. The history data 1435 may further include a reservation or sales history of products or services presented in the content.

The content management module 1427 manages distribution of content from the computer 200 to HMDs 120. In at least one aspect, the content management module 1427 distributes content in response to requests from the users 5. In at least one aspect, the content management module 1427 determines which content to be distributed based on recommendations to the users 5.

The sales management module 1428 receives reservation or purchase of products or services presented on the HMD 120. For example, the sales management module 1428 receives input of information (e.g., name, credit card number, mail address) necessary for reservation or purchase of products or services from the user 5, and transmits this information to an external server that manages the products or services.

(1) In at least one aspect, the content management module 1427 determines content suitable for the user 5 from among a plurality of types of content prepared in advance, based on the attribute of the user 5 of the HMD 120 and the goal of the user 5. The field-of-view image generation module 1439 presents the determined content to the HMD 120. In this manner, travelers like the user 5 are able to receive provision of information that matches their purposes even during travel on an aircraft or an international train.

(2) For example, the means of transportation includes an aircraft. In this case, the attribute of the user 5 includes the nationality of the user 5. The goal of the user 5 includes the destination of the aircraft. In this manner, the user 5 is able to acquire information on the destination while he/she is aboard the aircraft.

(3) In at least one aspect, the content management module 1427 determines content related to the place of departure of the aircraft based on the fact that the nationality of the user 5 is the same as the country to which the destination (e.g., the destination of the aircraft) belongs. The field-of-view image generation module 1439 presents content related to the place of departure. For example, while the user 5 is coming back from the travel destination, content related to the place of departure where the user 5 has just visited is presented to the HMD 120. The user 5 is thus able to enjoy memories of the travel destination while he/she is coming back home.

(4) In at least one aspect, the content management module 1427 generates data for presenting products available at the place of departure (that is, sold at the travel destination). Based on this data, the field-of-view image generation module 1439 presents the products to the HMD 120. The user 5 is able to reserve or purchase any of the products if he/she likes it. For example, the computer 200 presents a screen object for reservation or purchase to the HMD 120, and the user 5 inputs information necessary for reservation or purchase by using the hand object presented in the virtual space 11 or by operating a controller. In at least one aspect, based on the fact that the user 5 is seated in means of transportation (e.g., aircraft, train), information related to his/her seat may be used as information on the user 5 for reservation or purchase. The sales management module 1428 receives a purchase operation of products by the user 5. The user 5 thus does not have to wait in line in at a real store for purchase, and is able to spend his/her time effectively at the travel destination.

(5) In at least one aspect, the content management module 1427 determines content related to the destination of the aircraft based on the fact that the nationality of the user 5 differs from the goal of the user 5. The fact that the nationality of the user 5 differs from the goal means, for example, the user 5 is traveling abroad. In this case, the content management module 1427 searches the content data 1434 for content about the destination of the aircraft, that is, the place that the user 5 is going to visit. The field-of-view image generation module 1439 generates videos for introducing the destination or data for presenting services or products available at the destination. The user 5 is thus able to make a concrete plan, for example, about where to visit and which products to buy, before arriving at the destination, and thereby to spend his/her time effectively after arriving at the destination.

(6) In at least one aspect, the sales management module 1428 receives reservation or purchase of services or products by the user 5. The sales management module 1428 transmits information necessary for reservation of the services or products to a server of a business operator providing the services or products via the communication control module 540. The user 5 is thus able to reserve or purchase products or services in advance on the way to the destination, for example, whereby it is possible to reduce the waiting time for receiving the services or products.

(7) In at least one aspect, the content management module 1427 acquires a content viewing history of the user 5, and stores it as history data 1435 in the memory module 530. The content management module 1427 also transmits the viewing history to the content provider. The content provider is thus able to grasp the popularity of the content, and thereby to promote creation of more preferable content by giving incentives in accordance with the popularity, for example.

(8) In at least one aspect, the content management module 1427 acquires the content viewing history of the user 5, and presents content suitable for the user 5 based on the viewing history. In this manner, it is possible to suitably present content that draws the interest of the user 5.

(9) In at least one aspect, the content management module 1427 acquires a boarding history of the user 5. For example, the computer 200 may acquire information provided by an aviation company as the boarding history. The boarding history includes the goal and the departure date of the user 5. The content management module 1427 selects content suitable for the user 5 based on the boarding history. The field-of-view image generation module 1439 presents the selected content. For example, if the user 5 has visited the country that he/she is going to visit, the content for introducing the country may be presented, which may evoke the user's memories and cause renewed expectations for the travel. The content management module 1427 selects content suitable for the user 5 in accordance with the number of visits to the country that the user 5 is going to visit, for example. The content management module 1427 may select, as the content suitable for the user 5, content for introducing the country until the number of visits to the country reaches a threshold, for example, and content for introducing other countries than the country after the number of visits has reached the threshold. More specifically, the content management module 1427 may select content for introducing major tourist sites in a country when the user 5 is going to visit the country for the first time, and select content for introducing other tourist sites, shops, or the like in the country as the number of visits increases. In this manner, by presenting different types of content to users who are going to visit a country for the first time and to repeat travelers, it is possible to continuously draw the users' interest in the country. By presenting the user with content for introducing other countries near the country after the number of his/her visits to the country has reached the threshold, the user may have renewed expectations for the travel. In this context, when content for introducing other countries is presented in accordance with the number of visits to the country that the user is going to visit, the content management module 1427 may present countries related to the routes that the aviation company provides. To present countries related to the routes that the aviation company provides to the user 5, the content management module 1427 may refer to the nationality 1653 of the user 5 to thereby present the routes including the country indicated by the nationality of the user to the user 5.

(10) In at least one aspect, the reference line-of-sight specification module 1423 acquires movement of the line of sight of the user 5 based on the signal from the eye gaze sensor 140. The content management module 1427 transmits a movement history of the line of sight to the content provider via the communication control module 540. The provider may learn the position that draws the user's interest in the content through the movement of the line of sight, and thus is able to provide the user with right information for marketing purposes, for example. Since the reference line-of-sight specification module 1423 is able to acquire the movement history of the line of sight of the user 5, the content management module 1427 may determine content suitable for the user 5 based on the target to which the user 5 has watched in the content. For example, by specifying the target the user 5 has watched, as a viewing object, in certain content including buildings, meals, people, or the like through image recognition or other methods, the content that has drawn the interest of the user 5 may be selected.

(11) In at least one aspect, the content management module 1427 determines the goal of the user 5 based on a description on a ticket (e.g., boarding pass, train ticket, board ticket) for using means of transportation.

(12) For example, the content management module 1427 determines the goal of the user 5 by optically reading such a ticket with a camera (not shown) in a smartphone mounted on the HMD 120. Through a motion of the user 5, the user 5 may refresh his/her thoughts on the travel destination. At the same time, information on the user 5 is accurately collected, whereby content suitable for the user 5 may be provided.

(13) For example, the user 5 may use a see-through camera provided in the HMD 120 to take an image of the ticket. The content management module 1427 determines the goal and the attribute of the user 5 based on the information acquired through the image taken. The field-of-view image generation module 1439 presents a result of the determination to the monitor of the HMD 120. In this manner, the user 5, while wearing the HMD 120, visually observes outside circumstances surrounding the HMD 120 with the see-through camera and takes an image of the ticket with the see-through camera, whereby the user may receive content suitable for himself/herself.

(14) In at least one aspect, the content management module 1427 acquires information on the user 5 based on the seat number of the user 5 in the means of transportation. Such a configuration eliminates the need for the user 5 to input a destination or other information.

The motion sensor 300 detects the inclination of the HMD 120. The content management module 1427 prompts the user 5 to stretch his/her body based on the fact that the state of the HMD 120 has been fixed for a predetermined period of time. For example, the content management module 1427 presents a message for prompting the user to stretch his/her body on the monitor 130. Alternatively, the content management module 1427 outputs a voice message in this regard through the speaker 180.

In at least one aspect, the content management module 1427 acquires at least one of: information (e.g., place name, temperature, weather) on the starting place of the means of transportation, information (temperature, weather) on the goal, and information (preregistered user name, preference, and other attributes) on the user 5, and determines content to be presented to the user 5 based on such information. The field-of-view image generation module 1439 presents the content to the HMD 120.

[Technical Concept]

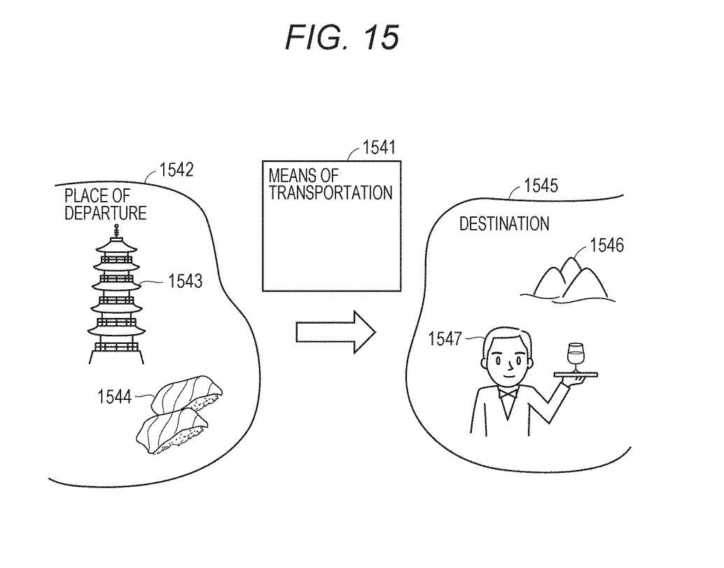

With reference to FIG. 15, a technical concept related to the present disclosure is described. FIG. 15 is a diagram of a mode in which a user is moving from a place of departure 1542 to a destination 1545 using means of transportation 1541. The place of departure 1542 and the destination 1545 may be in the same country or in different countries. The following describes a case in which the place of departure 1542 and the destination 1545 are in different countries.

In at least one aspect, the user is traveling from the place of departure 1542 to the destination 1545 using the means of transportation 1541. If the place of departure 1542 is the user's home country, the destination 1545 is an overseas travel destination. The destination 1545 has a tourist site 1546 and other tourist sites, and also has places that provide services such as a restaurant 1547. In this case, the means of transportation 1541 may provide content for introducing the destination 1545. For example, the means of transportation 1541 presents videos for introducing the tourist site 1546 and the restaurant 1547. The user, watching the videos, are able to raise his/her expectations for the travel to the destination 1545, which he/she is going to visit.

If the tourist site 1546 or the restaurant 1547 is an extremely popular place among travelers, the user is able to reserve a ticket for the tourist site 1546 or reserve a table in the restaurant 1547, while traveling on the means of transportation 1541. The user is able to reserve or purchase products or services after checking the products or services or the tourist site. Examples of the services may include, but not be limited to, restaurants, beauty services, and transportation. If a transportation ticket has been reserved (purchased), the goal of the transportation is used for estimating the place that the user 5 is going to visit, and thus, products or services related to the goal may be provided. In this manner, a future action of the user 5 is estimated based on advance purchase by the user 5, and it is thus possible to provide more desired content to the user 5, not depending on uncertain actions of the user.

In at least one aspect, there are some cases in which the country to which the place of departure 1542 belongs differs from the nationality of the user. In such cases, the place of departure 1542 is a place that the user has visited and the destination 1545 is the place to which the user is going to return. The place of departure 1542 has a tourist site 1543 and other tourist sites and a product 1544 and other specialties. In this case, the means of transportation 1541 may provide the user with content about the place of departure 1542. For example, the means of transportation 1541 may distribute videos for introducing the tourist site 1543 and the product 1544 to the HMD 120. While wearing the HMD 120, the user 5 can recall memories of the place that he/she has visited, in other words, the place of departure 1542. The user 5 who wants to buy the product 1544 may take a purchase procedure on a screen presented on the HMD 120.

In the above-described technical concept, the content is provided by using the HMD 120. The HMD 120 may be the one with an integrated monitor section and the one to which a smartphone is attachable. LCCs to which the above-described technical concept is applied may employ any of these. For example, the one to which a smartphone is attachable may be used on a rental basis, whereas the one with an integrated monitor section may be sold on a plane, and vice versa.

The content is, for example, 360-degree video content, and other types of content may be used. The content is not limited to the one created by a content provider, and may be videos or photographs taken by other travelers who visited the same place. The user is thus able to enjoy a wider variety of content, in addition to existing guidebooks. Even in such types of means of transportation as LCC aircrafts or international trains that have no monitor at every seat, the user 5 is able to receive the value of video content provided.

A content distributor or a business operator of means of transportation (i.e., an aviation company or a train or ship operating company) is able to act as agent for a product or service provider, and thereby to receive agency commissions.

Content suitable for the user 5 is provided, which makes selection of content easier even when in-flight entertainment is also available.

[Data Structure]

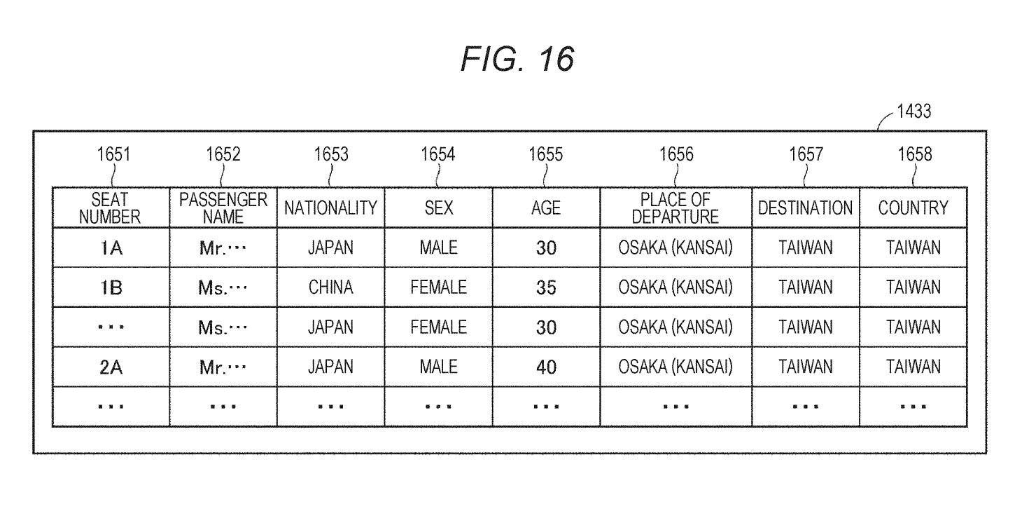

With reference to FIG. 16 to FIG. 18, a data structure of the computer 200 is described. FIG. 16 is a diagram of details of the user information 1433. The user information 1433 includes a seat number 1651, a passenger name 1652, the nationality 1653, a sex 1654, an age 1655, a place of departure 1656, a destination 1657, and a country 1658.

The seat number 1651 represents the seat at which a certain user is seated. The passenger name 1652 represents the name of the user. The nationality 1653 represents the nationality of the user. The sex 1654 represents the sex of the user. The age 1655 represents the age of the user. The place of departure 1656 represents the place of departure of the means of transportation. The destination 1657 represents the destination (flight destination) of the means of transportation. The country 1658 represents the country to which the destination belongs.

As the means of transportation departs from the place of departure 1542 to the destination 1545, the user information 1433 is stored in the memory module 530.

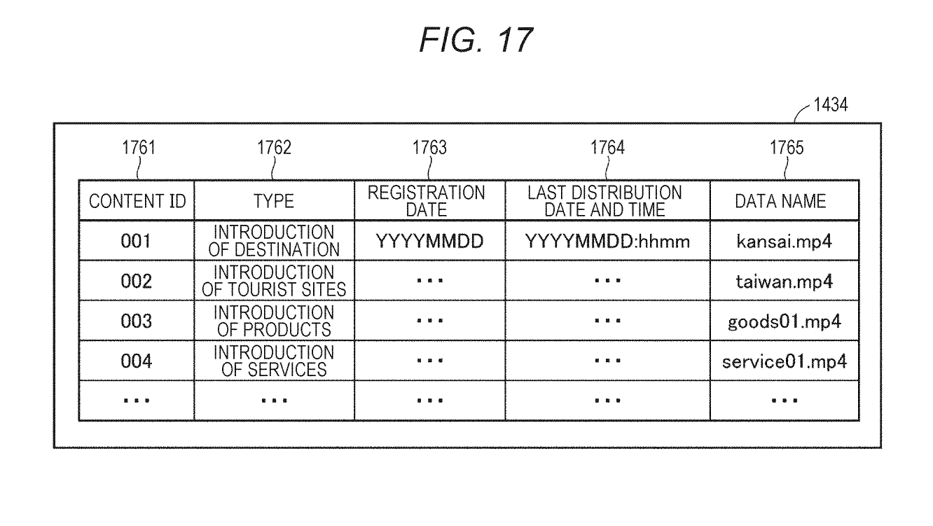

FIG. 17 is a diagram of details of the content data 1434. The content data 1434 includes a content ID 1761, a type 1762, a registration date 1763, a last distribution date and time 1764, and a data name 1765. The content ID 1761 identifies content to be provided in the means of transportation 1541. The type 1762 represents the type of the content. The registration date 1763 represents the date on which the content was registered in the means of transportation 1541. The last distribution date and time 1764 represents the last date and time on which the content was distributed to the user. The data name 1765 represents the data name (file) of the content.

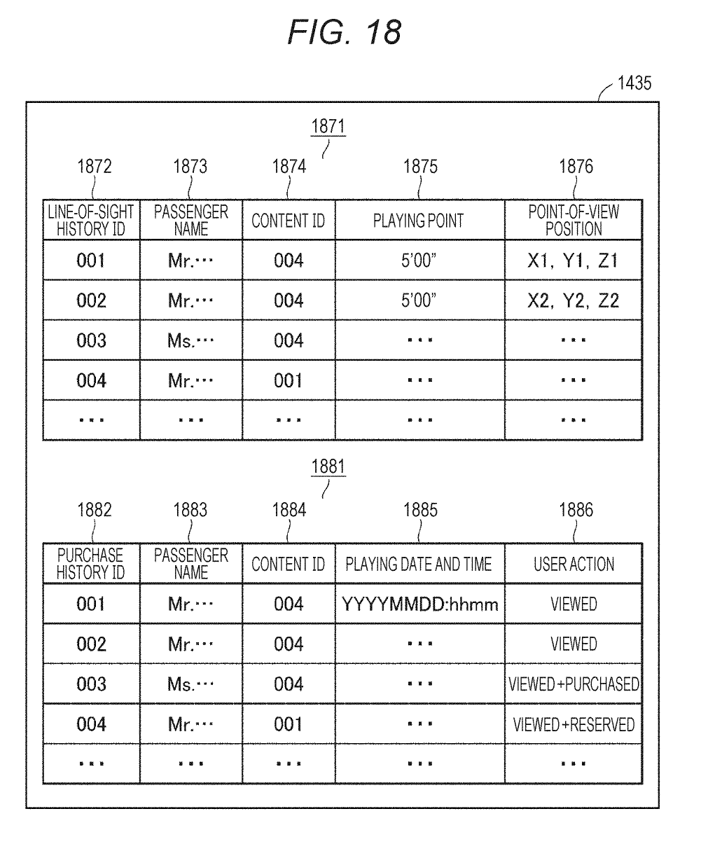

FIG. 18 is a diagram of details of the history data 1435. The history data 1435 includes a table 1871 and a table 1881. The table 1871 includes a line-of-sight history ID 1872, a passenger name 1873, a content ID 1874, a playing point 1875, and a point-of-view position 1876.

The line-of-sight history ID 1872 specifies a detected line-of-sight history. The passenger name 1873 represents the passenger name (in other words, the name of the user) whose line of sight was detected. The content ID 1874 identifies the content played when the line of sight was detected. The playing point 1875 represents the point in the content played when the line of sight was detected. This point may be represented by a lapse of time from the start of the content, for example. The point-of-view position 1876 represents the position of the detected point of view.

The table 1881 includes a purchase history ID 1882, a passenger name 1883, a content ID 1884, a playing date and time 1885, and a user action 1886. The purchase history ID 1882 specifies a detected history. The passenger name 1883 represents the passenger name (in other words, the name of the user) whose line of sight was detected. The content ID 1884 identifies the content played when the line of sight was detected. The playing date and time 1885 represents the time at which the playing of the content started. The user action 1886 represents a motion of the user to the content.

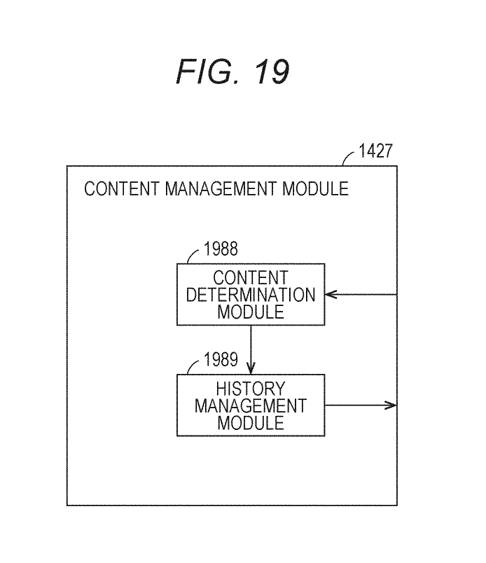

With reference to FIG. 19, the content management module 1427 is described. FIG. 19 is a diagram of a configuration of the content management module 1427. The content management module 1427 includes a content determination module 1988 and a history management module 1989. The content determination module 1988 determines content to be distributed to users. The history management module 1989 manages a distribution history of the content, a viewing history of the content, and a history of motions of the point of view viewing the content, for example.

[Control Structure]

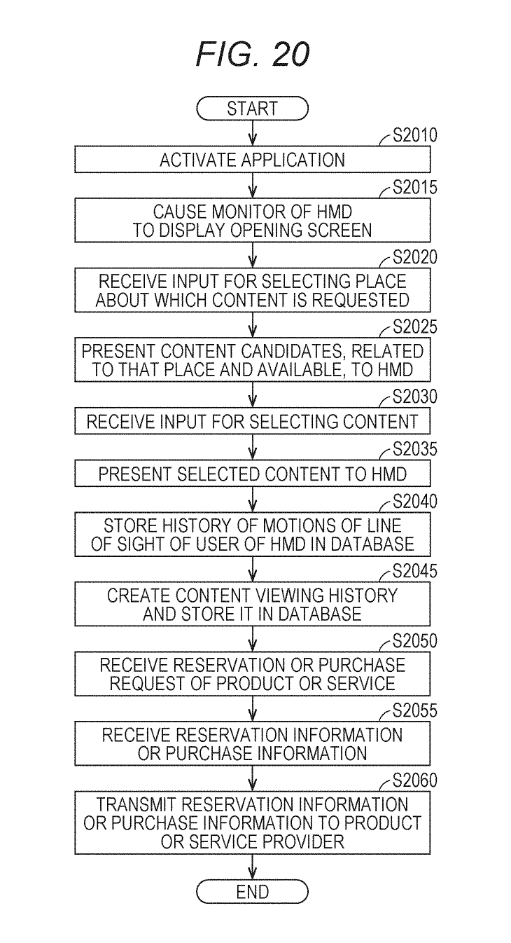

With reference to FIG. 20, a control structure of the computer 200 is described. FIG. 20 is a flowchart of processing to be executed by the computer 200 according to at least one embodiment of this disclosure. The computer 200 is, for example, provided to an aircraft, and is connected to other communication terminals, that is, the HMD 120 and other information communication terminals through wireless communication.

In Step S2010, the processor 210 activates an application. For example, the user 5 mounts a smartphone on a simplified VR headset (e.g., assembly cardboard to be integrated with the smartphone so as to function as a head-mounted display) in an aircraft, and activates an application downloaded to the smartphone in advance through in-flight Wi-Fi. As communication between the smartphone and the computer 200 in the aircraft is established based on the application, the processor 210 activates the application.

In Step S2015, the processor 210 causes the monitor 130 of the HMD 120 to display an opening screen prepared in advance by a content distribution operator.

In Step S2020, the processor 210 receives input for selecting a place about which content is requested. In at least one aspect, the user 5 of the smartphone takes an image of a boarding pass, or a QR code (registered trademark) or other types of two-dimensional matrix codes with a built-in camera, and the goal (e.g., the destination of the aircraft that the user is flying) based on this information is received as the place.

In Step S2025, the processor 210 presents content candidates that are related to the place and are available to the HMD 120. For example, the processor 210 accesses the memory module 530, reads out a list of content prepared in advance for each place, and provides it to the field-of-view image on the monitor 130 of the HMD 120.

In Step S2030, the processor 210 receives input for selecting content. For example, the user 5 has watched the list presented on the field-of-view image, which the user recognizes with the monitor 130, for a predetermined period of time, then the processor 210 recognizes that the corresponding content is selected.

In Step S2035, the processor 210 reads out data on the content from the memory module 530 and transmits the data to the HMD 120, thereby presenting the selected content to the HMD 120. The user 5 wearing the HMD 120 is thus able to reserve or purchase products or services as appropriate, while enjoying the content.

In Step S2040, the processor 210 stores a history of motions of the line of sight of the user of the HMD 120 as the table 1871 in a database, based on the signal from the eye gaze sensor 140. By tracking the line of sight of the user 5, it is possible to learn which part of the content the user 5 has paid his/her attention.

In Step S2045, the processor 210 creates a content viewing history and stores it in a database. As the content viewing history is fed back to the content provider, the provider is able to learn which content has drawn the interest of each user.

In Step S2050, based on a certain operation made by the user 5 for reservation or purchase, the processor 210 receives a reservation or purchase request of a product or a service from the HMD 120. The processor 210 causes, in response to the request, the HMD 120 to display a screen for prompting the user to input reservation information or purchase information. The user 5 uses his/her line of sight or operates a controller to input information necessary for reservation or purchase on the screen. In at least one aspect, if a credit card number or the like is registered as attribute information on the user 5, such information may appear on the screen as default values.

In Step S2055, based on the input of certain information made by the user 5, the processor 210 receives reservation information or purchase information (information on a person who has made a reservation or purchase, means of payment, and other information).

In Step S2060, the processor 210 transmits the reservation information or the purchase information to the provider of the product or the service. Upon receiving the reservation information or the purchase information, the provider may secure the product or secure the time required for providing the service. In at least one aspect, the processor 210 may charge the provider an agency commission in accordance with the transmission of the reservation information or the purchase information.

[Transition of Screens]

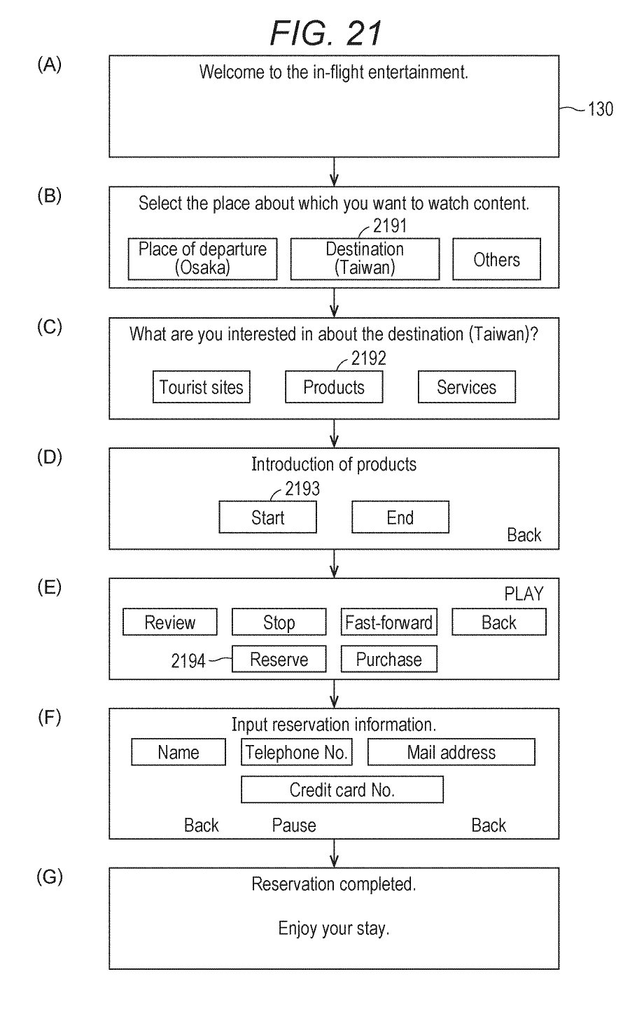

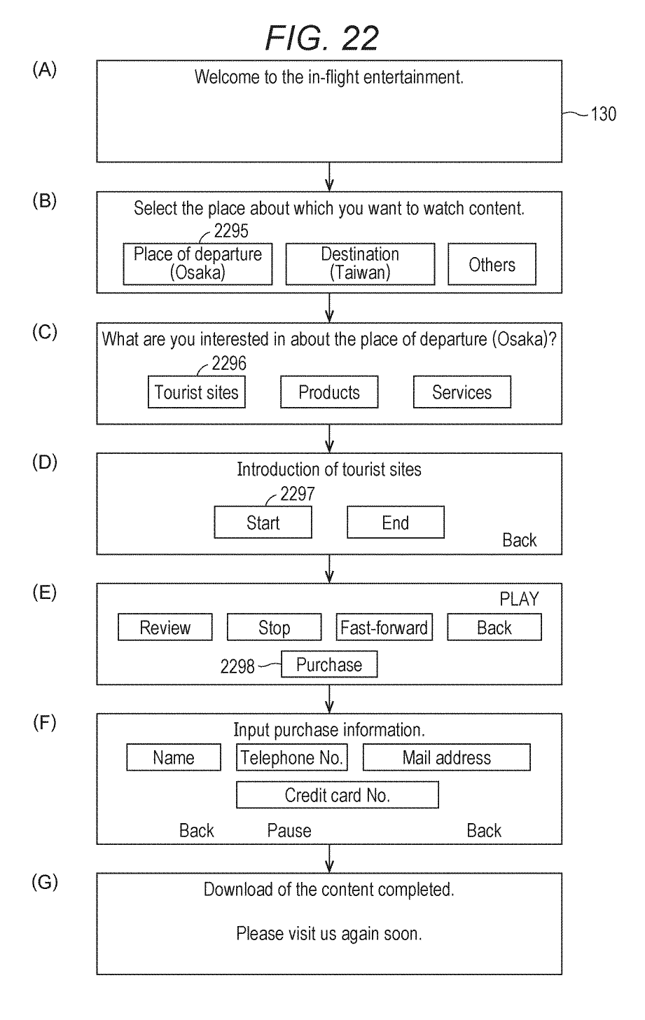

With reference to FIG. 21 and FIG. 22, a display mode of the monitor 130 is described. FIG. 21 is a diagram of a mode of providing content to a user going to Taiwan.

In State (A), the monitor 130 presents the opening screen in response to an operation made by the user 5 of the HMD 120. Subsequently, in State (B), the monitor 130 presents a screen for prompting the user to select a place about which content is requested. For example, the user 5 watches a place for a predetermined period of time or operates a controller, thereby selecting an icon 2191 presented in the virtual space 11. In State (C), if the icon 2191 is selected, the monitor 130 presents a screen for prompting the user to select what he/she is interested in about the corresponding destination. As the user 5 selects an icon 2192 in a similar selection operation to that described above, in State (D), the monitor 130 displays a screen for introducing products. As the user 5 selects an icon 2193 in a similar selection operation to that described above, in State (E), the monitor 130 starts playing the content. In this process, the monitor 130 provides user interface objects for controlling the playing of the content, based on an operation made by the user 5. Examples of the user interface objects include, in addition to review, stop, fast-forward, back, and other typical control icons, icons for reservation and purchase.

As the user 5 selects an icon 2194 in a similar selection operation to that described above to reserve a product, in State (F), the monitor 130 presents a screen for prompting the user to input reservation information. As the user 5 inputs all the items in a similar selection operation to that described above, in State (G), a message on completion of reservation is presented. In this manner, the user 5 is able to reserve or purchase what he/she wants on the way to the destination in the means of transportation, and thereby to avoid such a situation in which he/she fails to buy it because it is sold out or he/she forgets to buy it, for example.

FIG. 22 is a diagram of content provided in such a case in which a traveler who visited Osaka is going back home.

In State (A), the monitor 130 presents the opening screen in response to an operation made by the user 5 of the HMD 120. Subsequently, in State (B), the monitor 130 presents a screen for prompting the user to select a place about which content is requested. For example, the user 5 watches a place for a predetermined period of time or operates a controller, thereby selecting an icon 2295 presented in the virtual space 11. In State (C), if the icon 2295 is selected, the monitor 130 presents a screen for prompting the user to select what he/she is interested in about the corresponding place of departure. As the user 5 selects an icon 2296 in a similar selection operation to that described above, in State (D), the monitor 130 displays a screen for introducing tourist sites. As the user 5 selects an icon 2297 in a similar selection operation to that described above, in State (E), the monitor 130 starts playing the content for introducing tourist sites. In this process, the monitor 130 provides user interface objects for controlling the playing of the content, based on an operation made by the user 5. Examples of the user interface objects include, in addition to review, stop, fast-forward, back, and other typical control icons, an icon for purchase.

As the user 5 selects an icon 2298 in a similar selection operation to that described above to purchase a product, in State (F), the monitor 130 presents a screen for prompting the user to input purchase information. As the user 5 inputs all the items in a similar selection operation to that described above, in State (G), a message on completion of download of the content for introducing tourist sites is presented. The user 5 is thus able to purchase content data for introducing a place where he/she has just visited or a product in the means of transportation on the way back from the travel destination, which may evoke the user's memories of the travel destination.

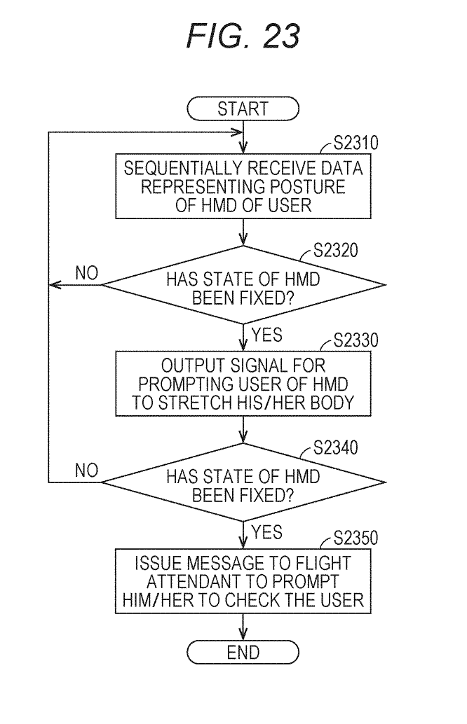

With reference to FIG. 23, a control structure of the computer 200 in at least one aspect is described. FIG. 23 is a flowchart of processing to be executed by a processor 210 in the computer 200.

In Step S2310, the processor 210 sequentially receives data representing the posture of the HMD 120 of the user 5.

In Step S2320, the processor 210 determines whether the state of the HMD 120 has been fixed. Upon determining that the state has been fixed (YES in Step S2320), the processor 210 switches control to Step S2330. Otherwise (NO in Step S2320), the processor 210 returns control to Step S2310.

In Step S2330, the processor 210 outputs a signal for prompting the user 5 of the HMD 120 to stretch his/her body. For example, the processor 210 transmits a signal for displaying a message for prompting the user to stretch his/her body so as to prevent the economy-class syndrome to the HMD 120. The HMD 120 displays a message based on the signal on the monitor 130. In at least one aspect, the processor 210 may transmit a signal for outputting a voice message in this regard to the HMD 120, instead of the signal for displaying a message. The HMD 120 outputs audio information based on the signal from the speaker 180.

In Step S2340, the processor 210 determines whether the state of the HMD 120 has been fixed. Upon determining that the state has been fixed (YES in Step S2340), the processor 210 switches control to Step S2350. Otherwise (NO in Step S2340), the processor 210 returns control to Step S2310, and the posture of the user 5 continues to be monitored.

In Step S2350, the processor 210 issues a message to a flight attendant to prompt him/her to check the user. For example, the processor 210 transmits a message in this regard to a monitor provided to the aircraft.

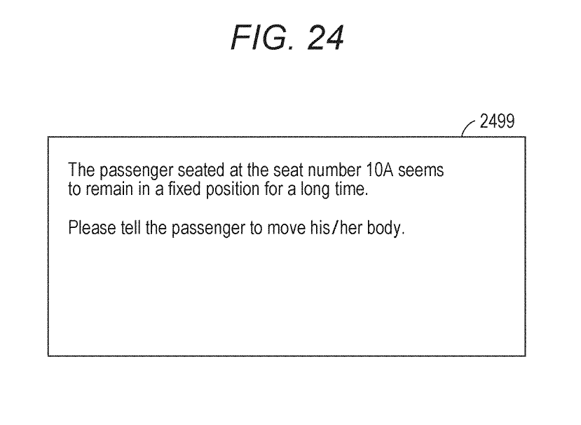

With reference to FIG. 24, a display mode of the monitor is described. FIG. 24 is a diagram of a display mode in a monitor 2499 provided to the aircraft. In at least one aspect, based on signals received from the computer 200, the monitor 2499 displays a message saying, “The passenger seated at the seat number 10A seems to remain in a fixed position for a long time. Please tell the passenger to move his/her body”.

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

The technical features disclosed above may be summarized in the following manner.

(Configuration 1) According to at least one embodiment of this disclosure, there is provided a method to be executed on the computer 200 for providing content in means of transportation. This method includes a step of defining the virtual space 11 provided by the HMD 120 connected to the computer 200, a step of determining content suitable for the user 5 from among a plurality of types of content prepared in advance, based on an attribute of the user 5 of the HMD 120 and a goal of the user 5, and a step of presenting the determined content to the HMD 120.

(Configuration 2) In at least one aspect, the means of transportation includes an aircraft. The attribute of the user 5 includes the nationality of the user 5. The goal of the user 5 includes the destination of the aircraft.

(Configuration 3) In at least one aspect, the step of determining content includes a step of determining content related to the place of departure of the aircraft based on the fact that the nationality of the user 5 is the same as the country to which the destination belongs. The step of presenting the content includes a step of presenting content related to the place of departure.

(Configuration 4) In at least one aspect, the method further includes a step of presenting a product available at the place of departure, and a step of receiving a purchase operation of the product by the user 5.

(Configuration 5) In at least one aspect, in the method, the step of determining content includes a step of determining content related to the destination of the aircraft based on the fact that the nationality of the user 5 differs from the goal of the user 5. The step of presenting the content includes a step of presenting videos for introducing the destination or services or products available at the destination. With such a configuration, videos on the destination or products/services may be presented at the departure.

(Configuration 6) In at least one aspect, the method further includes a step for receiving reservation or purchase of services or products by the user 5. With such a configuration, it is possible to reserve or purchase services or products on the way to the destination, for example, and thus to spend time effectively at the destination.

(Configuration 7) In at least one aspect, the method further includes a step for acquiring a content viewing history of the user 5, and a step for transmitting the viewing history to a content provider. With such a configuration, the content viewing history is fed back, which may lead to creation of better content.

(Configuration 8) In at least one aspect, the method further includes a step for acquiring a content viewing history of the user 5, and a step for presenting content suitable for the user 5 based on the viewing history. With such a configuration, it is possible to present optimum content based on the content viewing history.

(Configuration 9) In at least one aspect, the method further includes a step for acquiring a boarding history of the user 5, and a step for presenting content suitable for the user 5 based on the boarding history. With such a configuration, the content is provided based on the flight history, and it is thus possible to reduce such a case in which the same content is repeatedly provided, for example.

(Configuration 10) In at least one aspect, the method further includes a step for acquiring movement of the line of sight of the user 5, and a step for transmitting the line-of-sight movement history to a content provider. With such a configuration, it is possible to grasp the line-of-sight movement history as the degree of interest of the user 5 and thus to learn the preference of the user.

(Configuration 11) In at least one aspect, the method further includes a step for determining the goal of the user 5 based on a description on a ticket for using the means of transportation. With such a configuration, the goal is determined based on a description on the boarding pass, which eliminates the need for the user 5 to input the goal.

(Configuration 12) In at least one aspect, the determining step includes a step for determining the goal of the user 5 by optically reading the ticket. With such a configuration, the goal is determined based on a description on the boarding pass, which enables accurate input of the goal.

(Configuration 13) In at least one aspect, in the method, the step for determining the goal of the user 5 includes a step for taking an image of the ticket by using a camera in the HMD 120, a step for determining the goal and the attribute of the user 5 based on the information acquired through the image taken, and a step for presenting a result of the determination to the monitor of the HMD 120. With such a configuration, an external image is presented to the HMD 120 with a see-through camera, whereby the user 5 is able to easily confirm information recognized by the HMD 120.

(Configuration 14) In at least one aspect, the method further includes a step for acquiring information on the user 5 based on the seat number of the user 5 in the means of transportation.

(Configuration 15) In at least one aspect, the method further includes a step for detecting the inclination of the HMD 120, and a step for prompting the user 5 to stretch his/her body based on the fact that the state of the HMD 120 has been fixed for a predetermined period of time. With such a configuration, it is possible to prevent occurrence of what is called the economy-class syndrome.

(Configuration 16) In at least one aspect, there is provided a program for executing the method in any of the above-described configurations on the computer 200.

(Configuration 17) In at least one aspect, there is provided an apparatus for providing content, the apparatus including a memory configured to store the program described in Configuration 16, and a processor configured to execute a program.

(Configuration 18) In at least one aspect, there is provided a system for providing content for providing content to the user 5 in means of transportation. The system for providing content includes the HMD 120, and a terminal (e.g., smartphone) that includes a processor, a memory, and a monitor and is mountable on the HMD 120. The memory is configured to store a plurality of types of content prepared in advance. With the terminal mounted on the HMD 120, any of a plurality of types of content is displayed on the monitor, and the terminal is thus configured to present the content to the user 5 wearing the HMD 120. The terminal is configured to acquire at least one of: information on the starting place of the means of transportation, information on the goal, and information on the user 5, and to present the content to the user 5 in response to acquisition of such information.

In this manner, with the technique according to the present disclosure, it is possible to provide suitable content via a virtual space in accordance of the nationality and voyage destination of a passenger, which enables the passenger to effectively spend his/her time at the travel destination. The technique enables travelers to make advance purchase or reservation, enabling them to effectively spend their time at their travel destinations. Since no movement of the HMD 120 is detected while the passenger is sleeping, it is possible to accurately determine whether the content is actually being viewed. A passenger who has kept the same posture for a long time is prompted to move his/her body, which may reduce occurrence of the economy-class syndrome.

It is to be understood that the embodiments disclosed above are merely examples in all aspects and in no way intended to limit this disclosure. The scope of this disclosure is defined by the appended claims and not by the above description, and this disclosure is intended to encompass all modifications made within the scope and spirit equivalent to those of the appended claims.

1. A method comprising:
by using a computer associated with means of transportation for moving a user to a goal, specifying an attribute of the user and the destination;
determining first content from among a plurality of content candidates based on the specified attribute and the specified goal;
defining a virtual space;
playing the content in the virtual space;
detecting a motion of a head-mounted device (HMD) associated with the computer;
specifying a field of view (FOV) in the virtual space in accordance with the detected motion; and
displaying an image corresponding to the FOV on the HMD.

2. The method according to claim 1, wherein
the means of transportation includes an aircraft,
the attribute of the user includes nationality of the user,
the goal of the user includes a destination of the aircraft,
the content candidates are associated with place data, and
the first content is determined from among the content candidates based on the nationality or the destination and the place data.

3. The method according to claim 2, wherein the content candidate associated with the place data corresponding to a place of departure of the aircraft is determined to be the first content, in accordance with a fact that the nationality is same as a country to which the destination belongs.

4. The method according to claim 3, further comprising:
associating product data with the place data,
presenting the product data corresponding to the place data associated with the place of departure, and
receiving input of an operation for purchasing the product data from the user.

5. The method according to claim 2, wherein the content candidate associated with the place data corresponding to the destination is determined to be the first content, in accordance with a fact that the nationality differs from a country to which the destination belongs.

6. The method according to claim 5, wherein the first content is a video for introducing the destination or a video for introducing a service or a product available at the destination.

7. The method according to claim 2, further comprising:
acquiring history data indicating content viewed by the user in an external service, wherein
the attribute of the user includes preference of the user specified based on the history data,
the content candidates are associated with preference data related to the preference, and
the first content is determined from among the content candidates based on the nationality, the preference, the destination, the place data, and the preference data.

8. The method according to claim 2, further comprising:
acquiring boarding history data, related to the aircraft, of the user, and
specifying preference of the user related to the goal based on the boarding history data, wherein
the attribute of the user includes the preference, and
the first content is determined from among the content candidates based on the nationality, the preference, the destination, and the place data.

9. The method according to claim 2, further comprising:
acquiring line-of-sight movement data indicating movement of a line of sight of the user, by using the HMD, and
specifying preference of the user based on the line-of-sight movement data, wherein
the first content is determined from among the content candidates based on the nationality, the preference, the destination, and the place data.

10. The method according to claim 1, further comprising:
storing boarding data in the computer, the boarding data being specified by reading a ticket for using the means of transportation, and
determining the goal of the user based on the boarding data.

11. The method according to claim 10, further comprising:
acquiring the boarding data by reading the ticket by using a camera connected to the HMD,
specifying the goal and the attribute of the user based on the boarding data, and
presenting a result of the specifying to the HMD.

12. The method according to claim 1, further comprising:
detecting a motion of the HMD, and
prompting the user to move his/her body in accordance with a fact that the motion has been fixed for a predetermined period of time.
